(19) United States
(12) Patent Application Publication
(10) Pub. No.: US 2012/0081450 A1
(43) Pub. Date: Apr. 5, 2012

(54) TEST PATTERN FORMING METHOD, TRANSPORT ADJUSTING METHOD, AND IMAGE FORMING APPARATUS

(75) Inventors: Tatsuya NAKANO, Shiojiri-shi (JP); Masahiko YOSHIDA, Shiojiri-shi (JP); Michiaki TOKUNAGA, Shiojiri-shi (JP); Takeshi YOSHIDA, Shiojiri-shi (JP)

(73) Assignee: SEIKO EPSON CORPORATION, Tokyo (JP)

(21) Appl. No.: 13/249,082

(22) Filed: Sep. 29, 2011

(30) Foreign Application Priority Data
Sep. 30, 2010 (JP) 2010-220804

(51) Int. Cl. B41J 29/393

(52) U.S. Cl. 347/19

(57) ABSTRACT

A test pattern forming method is used in adjustment transport of an image forming apparatus, by the image forming apparatus which includes transport rollers transporting a medium in the sub-scanning direction and a plurality of nozzles arranged in the sub-scanning direction and repeats the transport and main scanning for moving the plurality of nozzles in the main scanning direction. The method includes forming a plurality of first patterns using a first nozzle among the plurality of nozzles, and forming a plurality of second patterns using a second nozzle among the plurality of nozzles. The plurality of first patterns is formed by repetitive transport of the medium by a first intermittent transport. The plurality of second patterns is formed by repetitive transport of the medium by a second intermittent transport. The acceleration of the first intermittent transport is more gradual than the acceleration of the second intermittent transport.

### BACKGROUND

1. Technical Field

The present invention relates to a technique for adjusting the transport of a medium by an image forming apparatus which repeats the transport of the medium in the sub-scanning direction and the ejection of ink accompanies a movement of nozzles in the main scanning direction.

2. Related Art

In the related art, an image forming apparatus such as an ink jet printer transports a sheet-like medium such as paper or film by driving transport rollers. If the transport rollers are eccentric, the rotation axis of a motor which drives the transport rollers is eccentric due to an error of mounting to a frame, the circumferences of the transport rollers are uneven, or a medium slides from the transport rollers, errors are caused in the transport distance of the medium that is elicited from a rotation angle of the transport rollers. Such errors generally include an AC component which is a transport error periodically found due to eccentricity and a DC component which is a transport error caused by the unevenness in the circumferences of the transport rollers or sliding of a medium.

JP-A-2002-273956, JP-A-2008-302659, and JP-A-2008-260168 disclose a technique in which the AC component and the DC component of transport errors are individually detected in a way of scanning a test pattern printed by an ink jet printer by a scanner and adjusting the transport of a medium in a way of predicting a transport error caused in a practical mode based on the transport error detected based on the test pattern.

For the AC component of the transport error caused by eccentricity, it is necessary to set a reference angle to the rotation angle of the motor, to divide 360° from the reference angle minutely into a plurality of angle sections, and to set a correction value for correcting a control amount for each angle section. On the other hand, the DC component of the transport error which is caused by sliding of a medium and transport rollers in a practical mode cannot be precisely predicted unless the sliding of the medium and transport rollers that occur during transport in the practical mode is reenacted.

However, according to the method disclosed in Patent Documents 1 to 3, since the pattern for detecting the AC component of the transport error and the pattern for detecting the DC component of the transport error are formed at the same time, each of the patterns is formed in the same transport mode. Therefore, according to the method disclosed in Patent Documents 1 to 3, there is a problem that the precision for detecting the AC and DC components of the transport error becomes low.

In addition, general printers have a plurality of printing modes such as a high-speed mode and a high-precision mode, but sliding of a medium that occurs by intermittent transport in each mode does not uniformly occur. For that reason, a test pattern is necessary for precisely predicting the sliding of a medium for each print mode.

### SUMMARY

An advantage of some aspects of the invention is to elevate precision of medium transport in an image forming apparatus.

(1) A test pattern forming method is for forming test patterns, which is used in adjustment transport of an image forming apparatus, by the image forming apparatus which includes transport rollers transporting a medium in the sub-scanning direction and a plurality of nozzles arranged in the sub-scanning direction and repeats the transport and main scanning for moving the plurality of nozzles in the main scanning direction, the method including forming a plurality of first patterns using a first nozzle among the plurality of nozzles, and forming a plurality of second patterns using a second nozzle among the plurality of nozzles, and the plurality of first patterns is formed by repetitive transport of the medium by a first intermittent transport, the plurality of second patterns is formed by repetitive transport of the medium by a second intermittent transport, and the acceleration of the first intermittent transport is more gradual than the acceleration of the second intermittent transport.

Herein, gradual acceleration means that an absolute value of the acceleration is relatively small. In addition, intermittent transport means a series of movements of transport rollers from starting movement of a medium that stands still to stopping the movement. In addition, the acceleration of intermittent transport means the rate of change in angle velocity of transport rollers during intermittent transport.

According to the present invention, a plurality of patterns and a plurality of second patterns constituting test patterns are formed by repeating intermittent transport and main scanning with mutually different acceleration. In other words, the acceleration of intermittent transport executed during the formation of adjacent two first patterns is more gradual than the acceleration of intermittent transport executed during the formation of adjacent two second patterns. The difference between a surface length of a transport roller passing through a contact point between the transport roller and a medium per unit time and the distance that the medium advances per unit time in intermittent transport (the difference refers to the amount of sliding) becomes large as an absolute value of angle acceleration of the transport roller becomes great. If it is anticipated that AC components of a transport error occur in a practical mode based on the test patterns with satisfactory accuracy, it is preferable to perform intermittent transport with shorter distance than in intermittent transport in the practical mode by gradually driving the transport roller in angle sections set with each correction value. If the test patterns formed based on the invention are used, AC components of a transport error in the practical mode caused by, for example, eccentricity of a transport roller can be anticipated from an arrangement interval of the plurality of first patterns formed on a medium by repeating a first intermittent transport with relatively gradual acceleration. In other words, according to the invention, by detecting the arrangement interval of the plurality of first patterns formed on the medium, it is possible to accurately anticipate AC components of a transport error in the practical mode excluding DC components caused by sliding of the medium from a transport roller. Furthermore, when the plurality of first patterns is to be formed by the first intermittent transport, sliding of a medium from the transport roller can occur. In addition, sliding occurring in the first intermittent transport is different from sliding occurring in the practical mode. However, under a condition where the amount of sliding is sufficiently suppressed, it can be regarded that sliding of some degree occurs in intermittent transport corresponding to mutually different angle sections. For example, an average of differences between arrangement intervals of a plurality of pairs of first patterns and a reference interval (arrangement interval as a control amount) of a plurality of pairs of first patterns may be regarded as the amount of sliding in the first intermittent transport. Therefore, if arrangement intervals of a plurality of pairs of first patterns formed on a medium are detected, it is possible to accurately anticipate AC components of a transport error excluding an error caused by sliding occurring in the practical mode.

In addition, if the test patterns formed based on the invention are used, it is possible to anticipate a transport error caused by sliding of a medium from a transport roller in a second intermittent transport from arrangement intervals of a plurality of second patterns formed on the medium. Herein, for example, if n+1 second patterns are formed on a medium by rotating the transport roller n times (n is a natural number), AC components of a transport error are removed, and therefore, the arrangement intervals of n+1 second patterns indicates DC components of the transport error. In addition, according to the invention, by forming second patterns by performing repetitive transport of a medium in the second intermittent transport with an absolute value of acceleration greater than that of the first intermittent transport, it is possible to include a transport error caused by the same sliding amount as in the practical mode in the arrangement intervals of the second patterns formed on the medium. Therefore, according to the invention, if the arrangement intervals of the second patterns are detected, it is possible to accurately anticipate DC components of a transport error in the practical mode excluding, for example, AC components.

As described above, if the test patterns formed based on the invention are used, it is possible to separately anticipate AC components and DC components of a transport error in the practical mode with accuracy. In addition, the test patterns formed based on the invention may also be applicable to accurately anticipate sliding of a medium occurring in two practical modes with different acceleration of intermittent transport. In other words, according to the invention, it is possible to enhance precision in medium transport in an image forming apparatus.

(2) According to the test pattern forming method, the distance of each transport by the first intermittent transport may be shorter than the distance of each transport by the second intermittent transport.

If it is intended that first patterns are used in detecting AC components of a transport error, it is possible to raise resolution power of an error when AC components of the transport error are corrected, by adopting the configuration. In addition, with the adoption of the configuration, since an absolute value of acceleration of a medium is large in the second intermittent transport in which the medium is transported to a relatively longer distance in one cycle of intermittent transport, the time necessary for forming the test patterns can be shortened.

(3) According to the test pattern forming method, the image forming apparatus has a test mode for adjusting the transport with the test patterns and a practical mode for forming an image with transport adjusted based on the test mode, and the acceleration of the first intermittent transport may be more gradual than the acceleration of intermittent transport in the practical mode, and the acceleration of the second intermittent transport may be the same as the acceleration of intermittent transport in the practical mode.

If the configuration is adopted, it is possible to separately anticipate the AC components and DC components of a transport error in the practical mode with accuracy. Furthermore, the acceleration of intermittent transport is “the same” means that the accelerations approximate each other in a range where the amounts of sliding of a medium from the transport roller caused by intermittent transport are equal.

(4) According to the test pattern forming method, each pattern of the plurality of first patterns may be formed every time the medium is transported by the first intermittent transport, and each pattern of the plurality of second patterns may be formed every time the medium is transported by the second intermittent transport.

If the configuration is adopted, the second intermittent transport is executed plural times while two second patterns are formed on the medium. If there is a blank between two second patterns, it is possible to complete transport of a medium necessary for forming two second patterns only with one cycle of intermittent transport. However, a transport error of a medium is problematic in a region where consecutive patterns are formed rather than in a blank region. In the region where consecutive patterns are formed, intermittent transport of a medium in the sub-scanning direction and driving of a nozzle in the main scanning direction are alternately performed. Therefore, in order to prevent deterioration of image quality caused by a transport error of a medium, it is desirable to form two second patterns by repeating the second intermittent transport plural times in the same manner in the practical mode even if there is a blank between the two second patterns.

(5) According to the test pattern forming method, the first nozzle may be different from the second nozzle, and at least one pattern among the plurality of first patterns may be positioned between two patterns among the plurality of second patterns in the sub-scanning direction.

If the configuration is adopted, since the length of the test patterns in the sub-scanning direction can be reduced, it is possible to form the test patterns in a region smaller than the medium.

(6) According to the test pattern forming method, the first nozzle may be positioned in the further downstream side than the second nozzle in the sub-scanning direction, and a process may be included in which one pattern among the plurality of first patterns and one pattern among the plurality of second patterns are formed in one main scanning after transport by the first intermittent transport and before transport by the second intermittent transport.

Since a length of the test patterns in the sub-scanning direction can also be reduced when the configuration is adopted, it is possible to form the test patterns in a region smaller than the medium.

(7) According to the test pattern forming method, if the sum of a rotation amount of the transport rollers in the repeated first intermittent transport is assumed to be a and the sum of a rotation amount of the transport rollers in the repeated second intermittent transport is assumed to be b, a≧1 and b≧1 may be possible.

Herein, the rotation amount means a rotation angle obtained by assuming 360° to be 1. In other words, repetition of the first intermittent transport and repetition of the second intermittent transport are not mixed, but a transport roller may rotate one or more times during the execution of a series of first intermittent transport, and the transport roller may rotate one or more times during the execution of a series of second intermittent transport.

(8) According to the test pattern forming method, if the distance of the plurality of nozzles in the sub-scanning direction is assumed to be L₁ and the distance of transport when the transport rollers rotate once is assumed to be L₂, L₁×2<L₂ may be possible.

In other words, the length of one circumference of a transport roller may exceed twice the distance between the centers from a nozzle at the upstream end to a nozzle at the downstream end.

(9) According to the test pattern forming method, the medium may be rolled paper.

When test patterns are formed on cut paper as a medium, there is a case where the test patterns are arranged on almost the entire medium. In addition, in a state where an upstream end of the cut paper faces a nozzle, only a transport roller arranged upstream the nozzle comes into contact with the cut paper, and a transport roller arranged downstream the nozzle does not come into contact with the cut paper. A transport error occurring in that state is a transport error of the transport roller arranged upstream of the nozzle. On the other hand, in a state where the downstream end of the cut paper faces the nozzle, only the transport roller arranged downstream of the nozzle comes into contact with the cut paper, and the transport roller arranged upstream of the nozzle does not come into contact with the cut paper. A transport error occurring in that state is a transport error of the transport roller arranged downstream of the nozzle. If the first intermittent transport and the second intermittent transport are executed by different transport rollers, both the arrangement interval of first patterns and the arrangement interval of second patterns are not grounds for accurately anticipating a transport error in the practical mode. With regard to this point, since a long margin can be set in the sub-scanning direction when test patterns are formed on cut paper as a medium, it is possible to apply the condition of the transport rollers coming into contact with the medium when the first patterns and the second patterns are formed on the medium to the practical mode.

Furthermore, the invention is valid as a transport adjustment method, an image forming apparatus, a test pattern forming program, a recording medium of a test pattern forming program, a transport adjustment program, and a recording medium of a transport adjustment program. Of course, such a recording medium may be a magnetic recording medium, a magneto-optical recording medium, and any recording medium which may be developed in the future.

### BRIEF DESCRIPTION OF THE DRAWINGS

The invention will be described with reference to the accompanying drawings, wherein like numbers reference like elements.

FIG. 1 is a schematic view showing a system configuration according to an embodiment of the invention.

FIG. 2 is a plane view according to the embodiment of the invention.

FIG. 3 is a broken-line graph showing the relationship between time and angle velocity of a motor according to the embodiment of the invention.

FIG. 4 is another broken-line graph showing the relationship between time and angle velocity of a motor according to the embodiment of the invention.

FIG. 5 is a flowchart according to the embodiment of the invention.

FIG. 6 is a schematic view showing scanned data according to the embodiment of the invention.

FIG. 7 is a schematic view showing a calculation method according to the embodiment of the invention.

FIG. 8 is another flowchart according to the embodiment of the invention.

FIG. 9 is another plane view according to the embodiment of the invention.

### DESCRIPTION OF EXEMPLARY EMBODIMENTS

Hereinafter, an embodiment of the invention will be described with reference to accompanying drawings. Furthermore, constituent elements corresponding to each drawing are given the same reference numerals and overlapping description will be omitted.

### 1. Overview

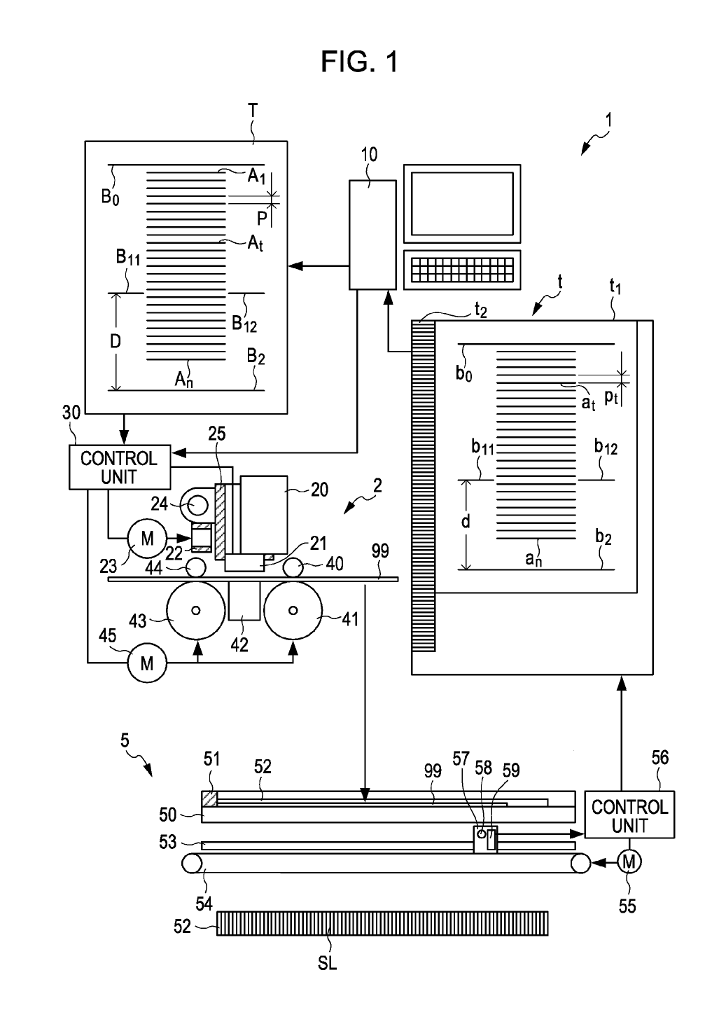

The configuration of a transport adjustment system 1 is shown in FIG. 1 as an embodiment of the invention. The transport adjustment system 1 includes a PC (Personal Computer) 10, a printer 2 connected to the PC 10, and a scanner 5. The transport adjustment system 1 is a system for adjusting the operation of the printer 2 to transport various sheets as print media. In other words, the PC 10 outputs test pattern data T to the printer 2 and makes the printer 2 form the test patterns on rolled paper 99. The scanner 5 scans the test patterns formed on the rolled paper 99 and supplies scanned data t indicating the test patterns to the PC 10. The PC 10 detects the skewness of the test pattern data T of the test patterns formed on the rolled paper 99 in the sub-scanning direction based on the scanned data t, and adjusts transport of the printer 2 based on the detected skewness.

### 2. Configuration of Printer

The printer 2 as an image forming apparatus is an ink jet printer which forms images on a sheet by alternately repeating transport for moving various sheets as media in the sub-scanning direction and main scanning for ejecting ink from nozzles while the nozzles are moved in the main scanning direction.

The printer 2 includes transport rollers 41 and 43, and a motor 45 that drives the transport rollers 41 and 43. The motor 45 is a stepping motor which rotates by a uniform angle (step angle) for every one pulse. The rotation angle of the motor 45 is controlled with the number of pulses of the driving pulse, and the rotation rate of the motor 45 is controlled with the frequencies of the driving pulse. The rotation axis of the transport rollers 41 and 43 is fixed with a rotary encoder not shown in the drawing. The rotation angle and rotation rate of the transport rollers 41 and 43 are detected by the rotary encoder. Driven rollers 40 and 44 contact the transport rollers 41 and 43 respectively. The respective transport rollers 41 and 43 and the driven rollers 40 and 44 are rotatably fixed to bearings not shown in the drawing. Since a sheet such as the rolled paper 99 is supplied between the transport rollers 41 and 43 and the driven rollers 40 and 44, the sheet is transported to the rotation direction of the transport rollers 41 and 43 by friction given between the sheet and the transport rollers 41 and 43. Specifically, the rolled paper 99 is pulled in between a platen 42 and a print head 21 by friction between the paper and the transport roller 43 in the downstream side, and the rolled paper 99 is pulled out from between the platen 42 and the print head 21 by friction between the paper and the transport roller 41 in the upstream side. Static friction given between the rolled paper 99 and the transport roller 41 in the upstream side exceeds static friction given between the rolled paper 99 and the transport roller 43 in the downstream side, and circumferential speed of the transport roller 41 in the upstream side slightly exceeds circumferential speed of the transport roller 43 in the downstream side. For this reason, the transport distance of the rolled paper 99 is decided by the rotation angle of the transport roller 41 in the upstream side in the state where the rolled paper 99 contacts both the transport rollers 41 and 43.

Herein, the printer 2 is operated in a test mode for printing the test patterns, and a practical mode for executing printing in a state where transport is adjusted based on the test patterns. In the test mode, a sheet is transported by either of a first intermittent transport in which the transport distance of one cycle corresponds to 568 steps of the motor 45 and a second intermittent transport in which the transport distance of one cycle corresponds to 1136 steps of the motor 45. In the practical mode, a sheet is transported by second intermittent transport in which the transport distance of one cycle corresponds to 1136 steps of the motor 45.

In addition, the printer 2 includes a print head 21 of which the nozzle is open on the bottom face and a motor 23 for moving the print head 21 to the main scanning direction. The print head 21 is provided with an ejection mechanism for ejecting ink from the nozzle in a known method such as a piezo method or a thermal method. A carriage 25 mounted with the print head 21 and an ink cartridge 20 is slidably installed in a guide rod 24. The guide rod 24 is fixed to a frame not shown in the drawing in parallel with the rotation axis of the transport rollers 41 and 43. An endless belt 22 driven by the motor 23 is fixed to the carriage 25. For this reason, the carriage 25 towed by the endless belt 22 as the motor 23 rotates is moved to a direction (main scanning direction) perpendicular to the direction (sub-scanning direction) in which the rolled paper 99 is transported.

The motors 45 and 23 and the print head 21 are controlled by a control unit 30 included in the printer 2. The control unit 30 includes a CPU, an EEPROM, a RAM, and an interface circuit. The control unit 30 controls the motor 45 and 23 and the print head 21 based on print data such as the test pattern data T supplied from the PC 10. The EEPROM of the control unit 30 stores various correction values for controlling the motors 45 and 23 and the print head 21 based on print data. The transport of the rolled paper 99 is adjusted by setting an AC correction value and a DC correction value that are correction values for controlling the motor 45.

AC correction values are set for every angle section obtained by dividing 360° from the reference angle of the motor 45 into equal intervals. The motor 45 according to the embodiment is configured to rotate 360° with 24992 steps, the width of each angle section is configured to correspond to 568 steps, and AC correction values are set for every 44 angle sections. The AC correction values have higher resolution power than the step resolution power of the motor 45. Specifically, the AC correction values have two-fold resolution power of the step resolution power, and one step is equivalent to the transport distance equivalent to 1/5760 inches, whereas an AC correction value is equivalent to the transport distance equivalent to 1/11520 inches.

### 3. Configuration of Test Patterns

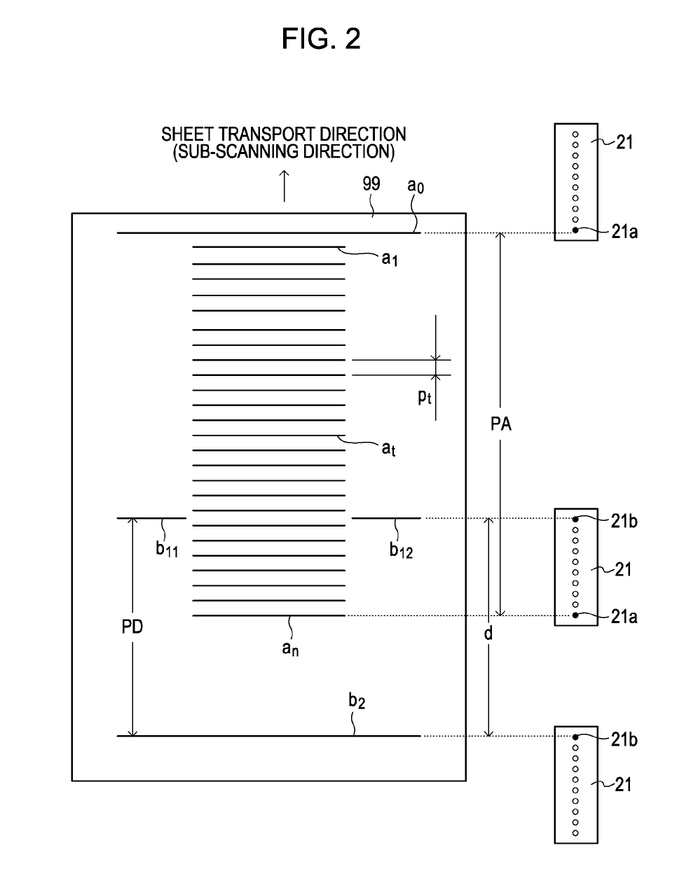

The test pattern formed on the rolled paper 99 as shown in FIG. 2 is formed based on the test pattern data T supplied from the PC 10 to the printer 2. The test patterns include first rules aₜ (t=0, 1, 2, . . . n) constituting a first pattern for detecting an AC component of a transport error and second rules b₁₁, b₁₂, and b₂ constituting a second pattern for detecting a DC component of a transport error.

The first rules aₜ each of which constitutes the first pattern have a one-dot line width, and are formed with ink ejected from one specific nozzle at a position of the sub-scanning direction corresponding to a first rule component Aₜ of the test pattern data T. A nozzle (first nozzle) 21a which ejects ink to form the first rules aₜ is located in the most downstream side of the print head 21. First rule components Aₜ constitute rows of lines in parallel with the main scanning direction. In addition, the first rule components Aₜ are arranged in the center of the main scanning direction for excluding the influence of skewness. In addition, the first rule components Aₜ are arranged in the sub-scanning direction with equal intervals of interval P. The interval P corresponds to the width of an angle section, and to the transport distance equivalent to 568 steps of the motor 45. A first rule a₀ also constitutes an inclination detection rule. The inclination detection rule a₀ is longer than other first rules in the main scanning direction. The number of intervals of the first rule components Aₜ is 88 equivalent to two times the number of sections. In other words, an AC component detection pattern PA including 89 first rules aₜ has a length of the sub-scanning direction equivalent to two full circumferences of the transport roller 41 and 88 intervals equal to two folds of the number of angle sections.

The second rules b₁₁ and b₁₂ which constitute the second pattern together and the second rule b₂ which constitutes the second pattern respectively have one-dot line width, and include lines in parallel with the main scanning direction. The second rules b₁₁, b₁₂, and b₂ are formed with ink ejected from one specific ink at positions of the sub-scanning direction corresponding to second rules B₁₁, B₁₂, and B₂ of the test pattern data T. A nozzle (second nozzle) 21b which ejects ink to form the second rules b₁₁, b₁₂, and b₂ is located in the most upstream side of the print head. The second rule components B₁₁ and B₁₂ are axisymmetrically arranged in the vicinity of the center line of the main scanning direction with the center axis of the main scanning direction as the axis of symmetry in order to exclude the influence of skewness. The positions of the second rule components B₁₁ and B₁₂ in the sub-scanning direction are equal. A distance D from the second rule components B₁₁ and B₁₂ to the second rule components B₂ in the sub-scanning direction corresponds to the length of one circumference of the transport roller 41. In other words, a DC component detection pattern PD including the second rules b₁₁, b₁₂, and b₂ has a length of the sub-scanning direction equivalent to one full circumference of the transport roller 41.

### 4. Printing of Test Patterns

Printing of the test patterns by the printer 2 is executed in a test mode for adjusting the transport of the rolled paper 99. When the printing is executed based on the test pattern data T output from the PC 10, at first, the inclination detection rule a₀ is formed on the rolled paper 99 with ink ejected from the nozzle 21a at the downstream end based on a first rule component A₀ of the test pattern data T.

When the inclination detection rule a₀ is formed on the rolled paper 99, the motor 45 is rotated by 568 steps for one angle section in which an AC correction value AC₁ is set, and then a first rule a₁ corresponding to a first rule component A₁ is formed on the rolled paper 99 with ink ejected from the same nozzle 21a at the downstream end.

Then, if a first rule aₜ₋₁ corresponding to a first rule component Aₜ₋₁ is formed on the rolled paper 99 with ink ejected from one nozzle 21a at the downstream end, the motor 45 is rotated by 568 steps for one angle section set with the AC correction value ACₜ, and the first rule aₜ corresponding to the first rule component Aₜ is formed on the rolled paper 99 with ink ejected from the same nozzle 21a. As such, by alternately repeating the main scanning and intermittent transport, the AC component detection pattern PA which includes 89 first rules aₜ and 88 intervals and has a length in the sub-scanning direction corresponding to two full circumferences of the transport roller 41 is formed on the rolled paper 99.

In main scanning in which a first rule a₈₈ at the downstream end is formed on the rolled paper 99 with ink ejected from the nozzle 21a at the downstream end, the second rules b₁₁ and b₁₂ corresponding to the second rule components B₁₁ and B₁₂ are formed on the rolled paper 99 by ink ejected from the nozzle 21b at the upstream end. In other words, the first rule a₈₈ forming the downstream end of the AC component detection pattern PA and the second rules b₁₁ and b₁₂ forming the upstream end of the DC component detection pattern PD are formed by the same main scanning.

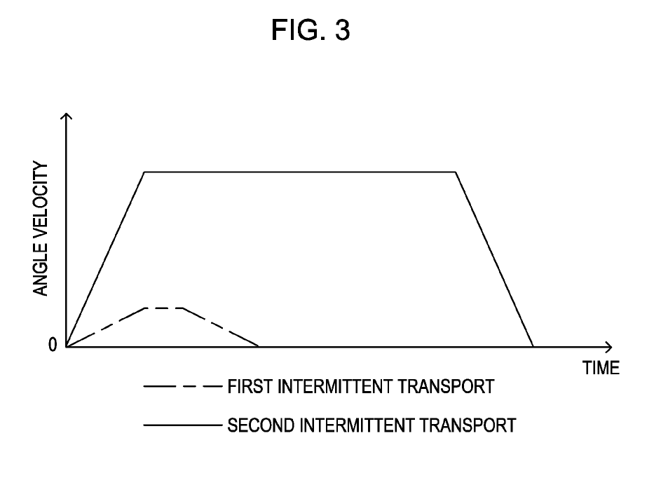

Slower acceleration is set in intermittent transport repeated until the first rule a₈₈ and the second rules b₁₁ and b₁₂ are formed on the rolled paper 99 (first intermittent transport) than in intermittent transport executed in the practical mode in which transport is adjusted. In addition, when the first rule a₈₈ and the second rules b₁₁ and b₁₂ are formed on the rolled paper 99, the rolled paper 99 is transported by the second intermittent transport with the same acceleration as in the intermittent transport executed in the practical mode. In other words, as shown in FIG. 3, further sudden acceleration and deceleration are shown in the second intermittent transport than in the first intermittent transport. Specifically, if the acceleration of an acceleration section in the first intermittent transport is set to α₁, the acceleration of a deceleration section in the first intermittent transport to β₁, the acceleration of an acceleration section in the second intermittent transport is set to α₂, and the acceleration of a deceleration section in the second intermittent transport to β₂, the following Equations (1) and (2) are established.

|α₁|<|α₂| (1)

|β₁|<|β₂| (2)

In addition, the distance to which the rolled paper 99 is transported by one cycle of the first intermittent transport is shorter than the distance to which the rolled paper 99 is transported by one cycle of the second intermittent transport.

After the first rule a₈₈ and the second rules b₁₁ and b₁₂ are formed on the rolled paper 99, the motor 45 is rotated by 24992 steps equivalent to one full circumference of the transport roller 41 and then the second rule b₂ corresponding to the second rule component B₂ is formed on the rolled paper 99 with ink ejected from the nozzle 21b at the upstream end. Therefore, the length of the DC component detection pattern PD including the second rules b₁₁, b₁₂, and b₂ in the sub-scanning direction is one full circumference of the transport roller 41.

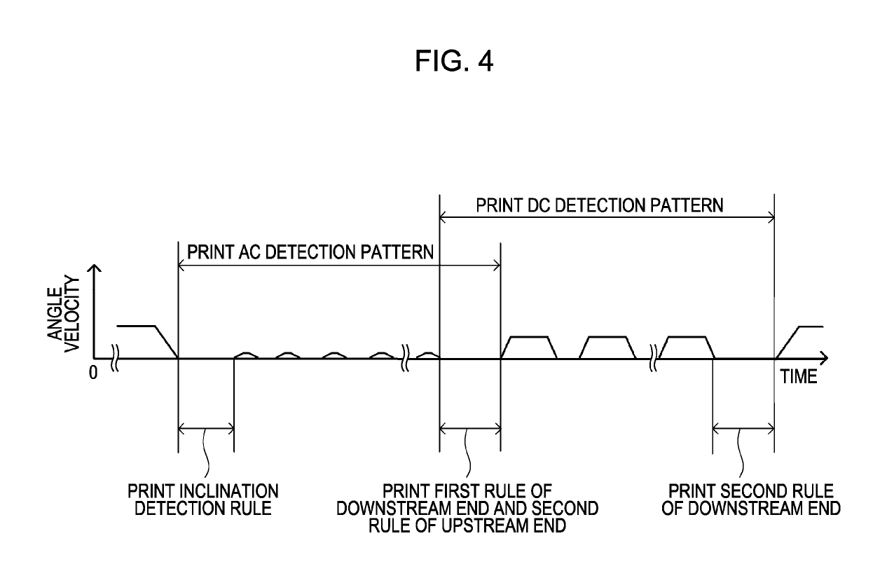

Transport from the second rules b₁₁ and b₁₂ to the second rule b₂ is executed by alternately repeating the second intermittent transport and stop as shown in FIG. 4. Specifically, in order to assuredly cancel logical seeking, dot components not shown in the drawing are included in the test pattern data T between the second rules b₁₁ and b₁₂ so as to repeat the second intermittent transport and ink ejection with a plurality of dots. In other words, by arranging the plurality of such dot components not included in the DC component detection pattern PD at an equal interval in the sub-scanning direction, the second intermittent transport and stop are controlled to be assuredly repeated during the formation of the DC component detection pattern PD so that printing is the same as in the practical mode.

As described above, in the test patterns printed on the rolled paper 99, a part of the AC component detection pattern PA including the first rule aₜ overlap a part of the DC component detection pattern PD including the second rules b₁₁, b₁₂ and b₂. In other words, a plurality of first rules including the first rule a₈₈ at the downstream end of the AC component detection pattern PA is arranged between the second rules b₁₁ and b₁₂ in the upstream side of the DC component detection pattern PD and the second rule b₂ in the downstream side of the DC component detection pattern PD. In order to acquire AC correction values for all angle sections of the motor 45, the length of the AC component detection pattern PA in the sub-scanning direction is necessary to be equal to or longer than the length of one circumference of the transport roller 41. In addition, if a DC correction value that does not include an AC component is to be acquired, the length of the DC component detection pattern PD in the sub-scanning direction is necessary to be equal to or longer than the length of one circumference of the transport roller 41. With the overlapping arrangement of the AC component detection pattern PA and the DC component detection pattern PD, the length of the entire test patterns including the AC component detection pattern PA and the DC component detection pattern PD in the sub-scanning direction can be reduced. Therefore, even if the radius of the transport roller 41 is great, test patterns including the AC component detection pattern PA and the DC component detection pattern PD can be formed in an area smaller than the rolled paper 99. For example, even if the length of one circumference of the transport roller 41 is 4.33 inches and exceeds two times the distance between the center of the nozzle 21b at the upstream end and the center of the nozzle 21a at the downstream end, the length of test patterns in the sub-scanning direction is 278.2 mm, which is shorter than a long side of an A4 size sheet. In this case, test patterns can be printed on cut paper of A4 size.

When upper and lower margins of cut paper for test patterns become small, however, the test patterns should be printed even in a state where the cut paper is transported by the transport roller 43 in the downstream side without contacting the transport roller 41 in the upstream side, and in a state where the cut paper is transported by the transport roller 41 in the upstream side without contacting the transport roller 43 in the downstream side. In this case, since a transport error appears in the print result of the test patterns different from in the practical mode in which the cut paper is transported by both transport rollers 41 and 43, the accuracy of a transport error in the practical mode that is anticipated based on the print result of the test patterns is lowered a little.

In addition, since the first intermittent transport for forming the AC component detection pattern PA in the test mode has more gradual acceleration than intermittent transport in the practical mode, the amount of sliding of the rolled paper 99 occurring between the transport roller 41 and in the first intermittent transport is smaller than the amount of sliding in the practical mode. Therefore, an AC component of a transport error in the practical mode can be anticipated with high accuracy based on the AC component detection pattern PA. In addition, since the transport distance by the first intermittent transport for forming the AC component detection pattern PA in the test mode is set to be shorter than the transport distance by the intermittent transport in the practical mode, it is possible to elevate correction resolution power of AC components corresponding to the number of angle sections of the motor 45. On the other hand, since the second intermittent transport for forming the DC component detection pattern PD in the test mode is set to have the same acceleration as the intermittent transport in the practical mode, the amount of sliding of the rolled paper 99 occurring between the transport roller 41 in the second intermittent transport is equal to the amount of sliding in the practical mode. Therefore, DC components of the transport error in the practical mode can be anticipated with high accuracy based on the DC component detection pattern PD. In addition, since the transport distance of the rolled paper 99 in the second intermittent transport is longer than the transport distance of the rolled paper 99 in the first intermittent transport, and an absolute value of acceleration in the second intermittent transport is greater than that in the first intermittent transport, the DC component detection pattern PD can be formed in a short period of time, and as a result, the time necessary for printing the entire test patterns can be shortened.

### 5. Configuration of Scanner

The test patterns printed on the rolled paper 99 are optically scanned by the scanner 5. The scanner 5 includes a platen glass 50 for placing the rolled paper 99, and a document guide 51 which has an end face in an L shape for positioning the rolled paper 99 on the platen glass 50. In addition, the scanner 5 includes a light source 58 for illuminating a document, a linear image sensor 59 for scanning the illuminated document, and a carriage 57 for transporting the linear image sensor 59 and the light source 58. The carriage 57 is installed slidably for a guide rod 53. The guide rod 53 is fixed to the frame not shown in the drawing in parallel with the platen glass 50. The carriage 57 is fixed to an endless belt 54 which is driven by the motor 55. The motor 55 is a stepping motor controlled by pulses output from a control unit 56 included in the scanner 5. The control unit 56 includes a CPU, an EEPROM, a RAM, and an interface circuit. The control unit 56 controls the motor 55, the light source 58, and the linear image sensor 59 based on a request received from the PC 10 and transfers scan data output from the linear image sensor 59 to the PC 10.

The intervals between the first rules and the intervals between the second rules constituting the test patterns are measured in a unit of pixels constituting the test pattern data t scanned by the scanner 5. An arrangement interval of pixels constituting the test pattern data t in the sub-scanning direction are determined by a rotation angle of the motor 55 rotating while adjacent arbitrary two lines are scanned by the linear image sensor 59. While the linear image sensor 59 scans the adjacent arbitrary two lines, distances that the carriage 57 moves are uneven due to errors. In order to remove the influence of the unevenness, a reference pattern scanned together with the test patterns is prepared.

The reference pattern is formed on a reference plate 52 affixed to the platen glass 50. The reference plate is formed with a plurality of slits SL constituting the reference pattern. The slits SL are drawn by an ultra-high accuracy laser with a 0.0353 mm-pitch. The reference plate 52 is affixed to the platen glass 50 so that the end face of the document guide 51 extending in the direction where the carriage 57 moves (sub-scanning direction) is brought into contact with an end face of the reference plate in the longitudinal direction. The slits SL of the reference plate 52 affixed as above are parallel with the scanner 5 in the main scanning direction.

### 6. Transport Adjustment Method

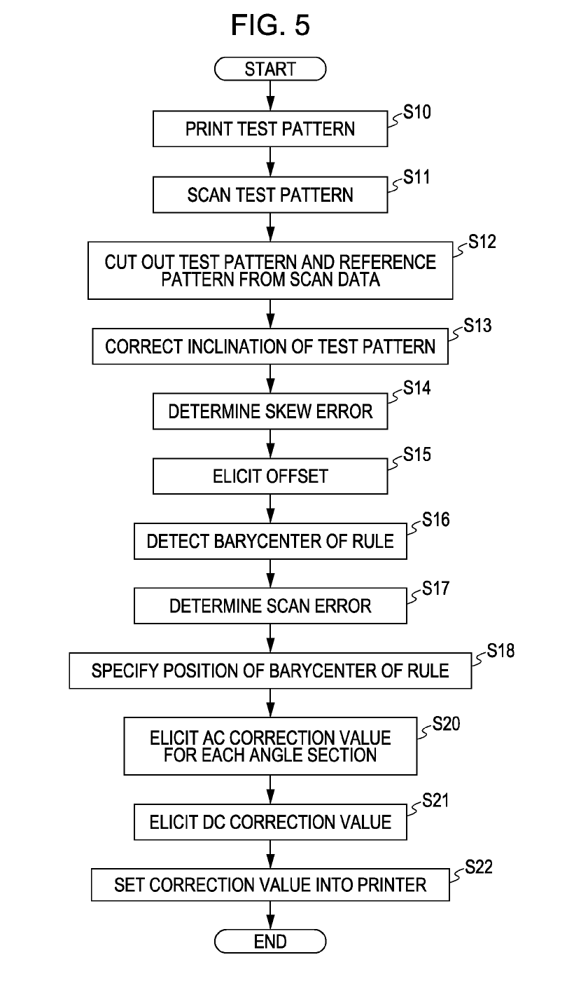

FIG. 5 is a flowchart showing the procedure of adjusting the transport of the printer 2 described above. Printing and scanning of the test patterns, analysis of scan data, and setting of a correction value to be described below are controlled by a transport adjustment program executed by the PC 10.

First, the PC 10 outputs the test pattern data T, and causes the printer 2 operating in the test mode to print the test patterns (S10). Printing of the test patterns is as described before.

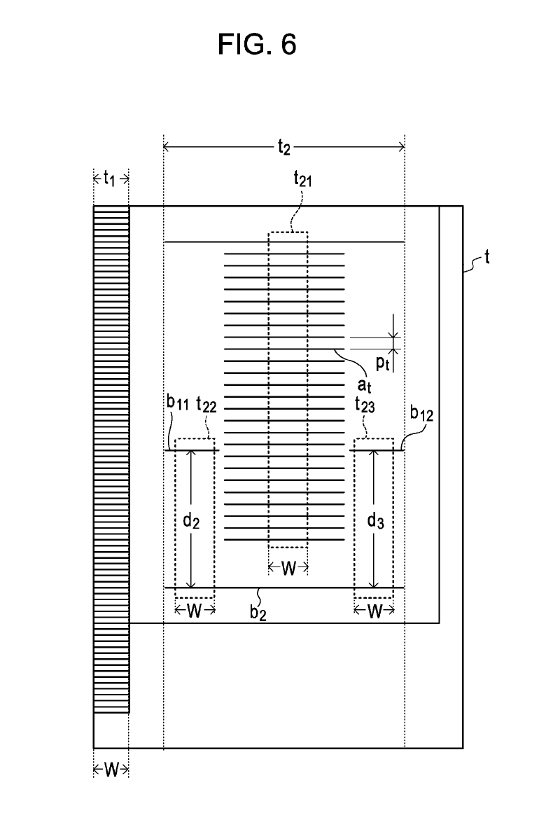

Next, an operator causes the rolled paper 99 on which the test patterns are printed to be placed on the platen glass 50 of the scanner 5 and causes the scanner 5 to scan the test patterns. As a result, the test pattern data t is input from the PC 10 to the scanner 5 (S11). The rolled paper 99 on which the test patterns are printed is placed on the platen glass 50 in a state where two sides of the reference plate 52 and the document guide 51 contact each other. As such, if the scanner 5 scans the test pattern in the state where the rolled paper 99 is placed on the platen glass 50, scan data t as shown in FIG. 6 is input to the PC 10.

Next, the PC 10 takes out a region t₂ corresponding to the test patterns and a region t₁ corresponding to the reference pattern from the scan data t (S12).

Then, the PC 10 corrects the inclination of the region t₂ corresponding to the test patterns (S13). Specifically, an angle θ forming the horizontal direction (the main scanning direction of the scanner) with the inclination detection rule a₀ is detected, and the region t₂ is rotated by the angle θ.

Next, the PC 10 detects whether or not skewness occurring during the printing of the test patterns is within the acceptable range, and if it is out of the acceptable range, the PC informs the error to stop the following process (S14). Specifically, it is detected whether or not the inclination of the second rule b₂ for the inclination detection rule a₀ is within the acceptable range, and if it is out of the acceptable range, the error is informed to stop the following process.

If the region t₂ is rotated in S13, the barycenter of each rule of the test patterns moves to the sub-scanning direction when viewed from a coordinate system of the test pattern data t that is not rotated. However, the position of each rule of the test patterns printed on the rolled paper 99 in the sub-scanning direction is specified by a reference of the position of the reference pattern scanned in the region t₁ not moving in the sub-scanning direction as viewed from the coordinate system of the test pattern data t. For this reason, correction is necessary for offsetting a movement of the barycenter of each rule by the rotation of the region t₂ to the sub-scanning direction when viewed from the coordinate system of the region t₁ not rotating. Thus, the PC 10 elicits a movement amount (offset) of each rule by the rotation of the region t₂ to the sub-scanning direction when viewed from the coordinate system of the region t₁ not rotating (S15).

Next, the barycenter of each rule of the test patterns appearing in the region t₂ and the barycenter of each rule of the reference pattern appearing in the region t₁ are detected (S16). Specifically, a concentration average of each line is elicited for a region t₂₁ including a part of each first rule and not including margins of both sides of each first rule in the region t₂, regions t₂₂ and t₂₃ including a part of each second rule and not including margins of both sides of each second rule in the region t₂, and each of the region t₁. Herein, the concentration average is a value obtained by dividing the sum of concentration (luminance) of each line in the regions t₁, t₂₁, t₂₂, and t₂₃ by a width W of each region (a length in the main scanning direction). Then, the position of the barycenter of each rule in the reference pattern and the test patterns in the sub-scanning direction (coordinate value) is detected with the position of a line in the sub-scanning direction which has the maximum value within a range where the concentration average is greater than a threshold value.

Next, the PC 10 determines whether or not the distance between the barycenters of rules (arrangement interval) is within the reference range, and when the distance exceeds the reference range, the PC 10 informs the error to stop the following process (S17). An error occurs when, for example, the concentration of a scanned rule is abnormally lowered due to disturbance such as shaking, or a rule is scanned twice. The reference range is set based on the presumed maximum transport error of the printer 2 and the presumed maximum scanning error or the scanner 5.

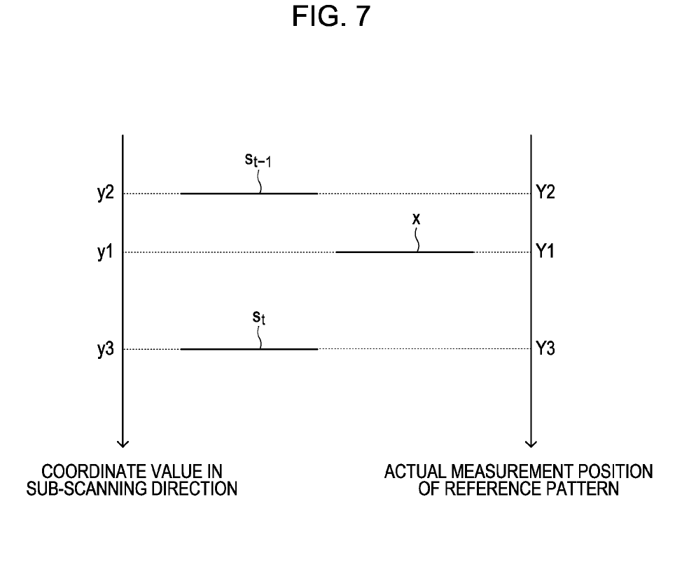

Next, the PC 10 applies the offset elicited in S15 and specifies the position of the barycenter of each rule of the test patterns in the sub-scanning direction (coordinate value) with a coordinate value of the barycenter of each rule of the reference pattern in the sub-scanning direction as reference (S18). The specific process is as follows. An arbitrary rule x constituting the test patterns is scanned between adjacent two rules sᵤ and sᵤ₊₁ of the reference pattern. As shown in FIG. 7 here, if coordinate values of the sub-scanning direction where the barycenter of rules x, sₜ₋₁, and sₜ are respectively set to y₁, y₂, and y₃ (y₃>y₂>y₁), and the positions of the rules sᵤ and sᵤ₊₁ in the sub-scanning direction that are measured in advance are set to Y₂ and Y₃ (Y₃>Y₂), the position Y₁ of the arbitrary rule x constituting the test patterns is specified by the following Equation (3).

Y₁=(Y₃−Y₂){(y₁−y₂)/(y₃−y₂)}+Y₂ (3)

In other words, the positions of rules constituting the test patterns in the sub-scanning direction are specified with a position where the slits SL of the reference pattern of which the precise position in the sub-scanning direction is specified in advance on the surface of the platen glass 50 is scanned as scan data t as reference.

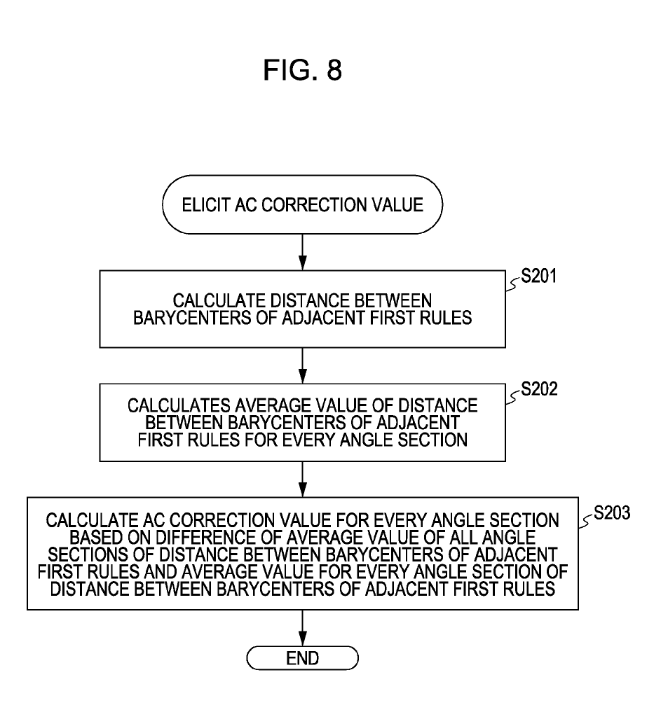

Next, the PC 10 elicits AC correction values for every angle section based on the specified positions of the first rules in the sub-scanning direction (S20). FIG. 8 is a flowchart showing the procedure for eliciting the AC correction values.

First, the distance between the barycenters of adjacent first rules is calculated (S201). Specifically, if the position of the first rule aₜ in the sub-scanning direction is specified as Yₜ, the distance pₜ between the barycenters of the first rule aₜ and the first rule aₜ₋₁ is calculated based on the following Equation (4). In the following Equation (4), t=1, 2, . . . , 88.

pₜ=Yₜ−Yₜ₋₁ (4)

Herein, pₜ is the sum of a logical value of the transport distance of one cycle of the first intermittent transport, a DC component of a transport error occurring in the first intermittent transport, and an AC component of a transport error occurring in the first intermittent transport.

Next, an average value Ave(t) of the distance between two barycenters corresponding to the same angle section is calculated based on the following Equation (5) (S201). “44” is the number of angle sections. In the following Equation (5), t=1, 2, . . . , 44.

Ave(t)=pₜ+pₜ₊₄₄ (5)

If the Ave(t) is obtained, transport errors caused by sliding of the rolled paper 99 between the transport roller 41 irregularly occurring for each angle section are averaged.

Next, a value obtained by subtracting the logical value of the distance between the barycenters of first rules from the average value Ave(t) of the distance between the two barycenters corresponding to the same angle section is calculated for each angle section as a first intermediate value S₁(t).

Next, an AC correction value Adj(t) is calculated for each angle section based on the difference between an average value p_{A} of the distance pₜ between barycenters of adjacent first rules and the first intermediate value S₁(t) (S202).

In detail, first, the average value p_{A} of the distance pₜ between barycenters of adjacent first rules is calculated based on the following Equation (6).

p_{A}=(p₁+p₂+ . . . +p₈₈)/88 (6)

p_{A} is equivalent to an average value of DC components of a transport error occurring in the first intermittent transport of two cycles for all the angle sections. Since the transport distance by the first intermittent transport of each angle section is short, it does not matter that p_{A} is regarded as a DC component of a transport error occurring in the first intermittent transport for each angle section.

Thus, the DC component of the transport error in the first intermittent transport is removed by subtracting p_{A} from the first intermediate value S₁(t), and a value obtained by converting a numerical unit from pixel to ½ steps of the motor 45 is calculated as an AC correction value AC(t) of each angle section. When the numerical unit is converted from pixel to ½ steps, the AC correction value AC(t) for each angle section is rounded off to the nearest integer, fractions that are cut or rounded off are added to an AC correction value AC′(t+1) which is before being rounded off to the nearest integer. Then, the AC correction value (44) of the final angle section has a value obtained by inverting positive or negative of the sum from the AC correction value AC(1) to the AC correction value AC(43) so that the total of the AC correction values of all the angle sections is 0.

If the AC correction value AC(t) for all the angle sections is elicited as above, next, the PC 10 elicits a DC correction value DC (S21). Specifically, first, distances between barycenters of second rules d₂ and d₃ are calculated for each of regions t₂₂ and t₂₃ shown in FIG. 6, and an average value of the calculated distances between barycenters d₂ and d₃ is calculated as a second intermediate value S₂. Next, a value obtained by subtracting a logical value of the distance between barycenters of the second rules b₁₁ and b₁₂ and the second rule b₂ from the second intermediate value S₂ is calculated, and a value rounded off to the nearest integer by converting a numerical unit from pixel to one step of the motor 45 is calculated as the DC correction value DC.

Next, the PC 10 sets the AC correction value AC(t) and the DC correction value DC in the printer 2. The AC correction value AC(t) and the DC correction value DC are written in the EEPROM of the control unit 30 in the printer 2 in the format shown in Table 1 below. Furthermore, a correction value resolution converting coefficient in Table 1 refers to a value obtained by dividing the resolution power of a AC correction value (11520 dpi) equivalent to ½ a step of the motor 45 by the transport resolution power (5760 dpi) corresponding to one step of the motor 45.

TABLE 1

| Address | Subject | Unit | Bytes | Example |
|---|---|---|---|---|
| 1 | DC correction value: DC | 1/5760 | 2 | 3 |
| | | inches | | |
| 3 | Number of steps/1 rotation | 1/5760 | 2 | 24992 |
| | | inches | | |
| 5 | Number of angle sections | | 2 | 44 |
| 7 | Correction value resolution | | 2 | 2 |
| | converting coefficient μ | | | |
| 9 | AC correction value: AC(1) | 1/11520 | 2 | −1 |
| | | inches | | |
| 11 | AC correction value: AC(2) | 1/11520 | 2 | 0 |
| | | inches | | |
| . | . | . | . | . |
| . | . | . | . | . |
| . | . | . | . | . |
| 95 | AC correction value: AC(44) | 1/11520 | 2 | 1 |
| | | inches | | |

### 7. Adjustment of Transport

If the AC correction value AC(t) and the DC correction value DC are set in the printer 2, transport of the printer 2 is adjusted as follows.

The AC correction value AC(t) indicates a value which raises and reduces the number of pulses applied to the motor 45 for one cycle of intermittent transport in a transport mode in which the transport distance for one cycle of intermittent transport is 568/11520 inches. In addition, DC correction value DC indicates a value which raises and reduces the number of pulses applied to the motor 45 for one cycle of the transport roller 41. Accordingly, the printer 2 sets the number of pulses P applied to the motor 45 for one cycle of transport according to the distance of one cycle of transport in the practical mode. Furthermore, the number of pulses P applied to the motor 45 is set for one cycle of transport according to angle sections of the motor 45 corresponding to the one cycle of transport.

When one cycle of transport which is a target transport distance F (step) corresponds only to an angle section t of the motor 45, the number of pulses P applied to the motor 45 for the one cycle of transport is calculated based on the following Equation (7).

P=AC(t)×(1/μ)×F/568+DC×(F/24992) (7)

When one cycle of transport which is a target transport distance F (step) corresponds to angle sections t−1 and t of the motor 45, the angle section t−1 of the motor 45 to a target transport distance f (step), and the angle section t of the motor 45 to a remaining target transport distance F−f (step), the number of pulses P applied to the motor 45 for the one cycle of transport is calculated based on the following Equation (8).

P=AC(t−1)×(1−μ)×f/568+AC(t)×(1−μ)×(F−f)/568+DC×(F/24992) (8)

When one cycle of transport which is a target transport distance F (step) corresponds to angle sections t₁ to t₂ (t₂−t₁>1) of the motor 45, the angle section t₁ to a target transport distance f₁ (step), and the angle section t₂ to a target transport distance f₂ (step), the number of pulses P applied to the motor 45 for the one cycle of transport is calculated based on the following Equation (9).

$$P = AC ( {t}_{1} ) \times ( 1 / μ ) \times {f}_{1} / 568 + AC ( {t}_{1} + 1 ) + AC ( {t}_{1} + 2 ) … + AC ( {t}_{2} ) \times ( 1 / μ ) \times {f}_{2} / 568 + DC \times ( F / 24992 ) \qquad ( 9 )$$

In the above-described transport adjustment method, based on the average value Ave(t) of a plurality of arrangement intervals corresponding to the same angle section (t), transport corresponding to the angle section (t) is adjusted. For this reason, transport errors caused by sliding of the rolled paper 99 with the transport roller 41 irregularly occurring for every angle section are averaged. In addition, an AC correction value is set so that the total of a plurality of AC correction values corresponding to one rotation of an angle section is zero. Therefore, transport can be adjusted by precisely anticipating AC components in transport errors and transport accuracy of a sheet in the printer 2 can be raised.

### 8. Other Embodiment

Furthermore, the technical scope of the invention is not limited to the above-described embodiment, and there is no doubt that various modifications can be implemented within a scope not departing from the gist of the invention.

For example, test patterns can be configured such that the AC detection pattern PA and the DC detection pattern PD do not overlap each other in the sub-scanning direction. In that case, a first rule constituting the AC detection pattern PA and a second rule constituting the DC detection pattern PD may be formed with ink ejected from the same nozzle. In addition, in that case, the first rule and the second rule are not formed in the same main scanning.

In addition, using the nozzle in the furthest downstream side as a first nozzle corresponding to a pattern to be formed in the upstream side and using the nozzle in the furthest upstream side as a second nozzle corresponding to a pattern to be formed in the downstream side is for reducing the length of test patterns in the sub-scanning direction at the maximum, but if the first nozzle is located at a further downstream side than the second nozzle, the length of the test patterns in the sub-scanning direction can be reduced by the distance the first nozzle and the second nozzle.

In addition, since there is a case where the concentration of dots is not stable depending on nozzles due to characteristics of the nozzles, a nozzle with stable concentration of dots is selected and the AC detection pattern PA and the DC detection pattern may be formed with ink ejected from the selected nozzle.

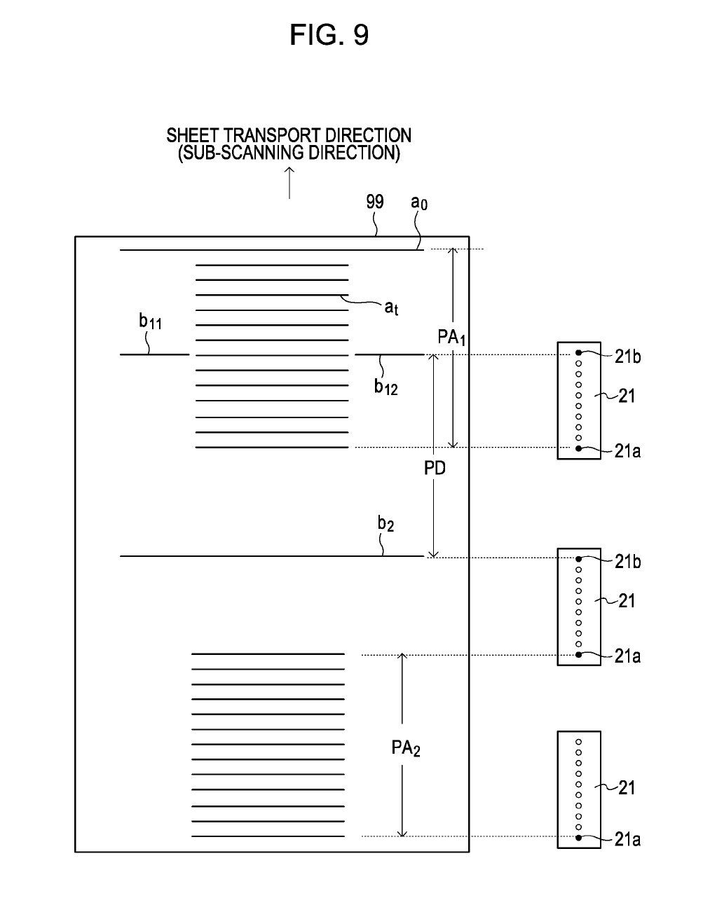

In addition, as shown in FIG. 9, test patterns can be configured such that two AC detection patterns PA₁ and PA₂ each of which is constituted by the same number of first rules aₜ can be arranged apart from each other in the sub-scanning direction, and the DC detection pattern PD is arranged so as to overlap a part of the AC detection pattern PA₁ in the upstream or the downstream side. In that case, main scanning for forming first rules and second rules in the same scanning is executed twice.

In addition, the length of the AC detection pattern in the sub-scanning direction may be one circumference of the transport roller 41. For example, the total length of the two AC detection patterns PA₁ and PA₂ in the sub-scanning direction shown in FIG. 9 may be one circumference of the transport roller 41. In addition, the DC detection pattern may be separated in plural, and the total length of the plurality of separated DC detection patterns in the sub-scanning direction may be one circumference of the transport roller 41.

In addition, the test patterns according to the invention can be used in adjustment of transport in an image forming apparatus which has a plurality of practical mode types in which media are transported by different intermittent transport. For example, first rules can be used for detecting transport errors in a high-precision print mode and second rules can be used for detecting transport error in a high-speed print mode. In that case, AC components and DC components in a transport error are not separated. In such a case, not only the length of a pattern in the sub-scanning direction constituted by first rules for detecting a transport error in the high-precision print mode in which acceleration of transport is gradual but also the length of a pattern in the sub-scanning direction constituted by second rules for detecting a transport error in the high-speed print mode in which acceleration of transport is sudden may be shorter than the length of one circumference of a transport roller. This is because, if transport errors in each practical mode are to be anticipated without separating AC components, the errors can be anticipated when the length of a pattern in the sub-scanning direction is not equal to or longer than one circumference of a roller.

In addition, a first pattern constituting the AC detection pattern may be a pattern other than a line, and a second pattern constituting the DC detection pattern also may be a pattern other than a line. For example, patches with different concentrations may be arranged in the sub-scanning direction to form the AC detection pattern.

In addition, the arrangement interval of each pattern is not limited to the distance between barycenters of patterns, but may be the length of a gap between two adjacent patterns, and may be the distance between one-side ends of adjacent two patterns.

What is claimed is:

1. A test pattern forming method for forming test patterns, which is used in adjustment transport of an image forming apparatus, by the image forming apparatus which includes transport rollers transporting a medium in the sub-scanning direction and a plurality of nozzles arranged in the sub-scanning direction and repeats the transport and main scanning for moving the plurality of nozzles in the main scanning direction, the method comprising:
forming a plurality of first patterns using a first nozzle among the plurality of nozzles; and
forming a plurality of second patterns using a second nozzle among the plurality of nozzles,
wherein the plurality of first patterns is formed by repetitive transport of the medium by a first intermittent transport,
wherein the plurality of second patterns is formed by repetitive transport of the medium by a second intermittent transport, and
wherein the acceleration of the first intermittent transport is more gradual than the acceleration of the second intermittent transport.

2. The test pattern forming method according to claim 1, wherein the distance of each transport by the first intermittent transport is shorter than the distance of each transport by the second intermittent transport.

3. The test pattern forming method according to claim 1,
wherein the image forming apparatus has a test mode for adjusting the transport with the test patterns and a practical mode for forming an image with transport adjusted based on the test mode,
wherein the acceleration of the first intermittent transport is more gradual than the acceleration of intermittent transport in the practical mode, and
wherein the acceleration of the second intermittent transport is the same as the acceleration of intermittent transport in the practical mode.

4. The test pattern forming method according to claim 1,
wherein each pattern of the plurality of first patterns is formed every time the medium is transported by the first intermittent transport, and
wherein each pattern of the plurality of second patterns is formed every time the medium is transported by the second intermittent transport.

5. The test pattern forming method according to claim 1,
wherein the first nozzle is different from the second nozzle, and
wherein at least one pattern among the plurality of first patterns is positioned between two patterns among the plurality of second patterns in the sub-scanning direction.

6. The test pattern forming method according to claim 5,
wherein the first nozzle is positioned further to the downstream side than the second nozzle in the sub-scanning direction, and
wherein a process is included in which one pattern among the plurality of first patterns and one pattern among the plurality of second patterns are formed in one main scanning after transport by the first intermittent transport and before transport by the second intermittent transport.

7. The test pattern forming method according to claim 1, wherein, if the sum of a rotation amount of the transport rollers in the repeated first intermittent transport is assumed to be a and the sum of a rotation amount of the transport rollers in the repeated second intermittent transport is assumed to be b, the following relationship is satisfied:
a≧1 and b≧1.

8. The test pattern forming method according to claim 1, wherein, if the distance of the plurality of nozzles in the sub-scanning direction is assumed to be L₁ and the distance of transport when the transport rollers rotate once is assumed to be L₂, the following relationship is satisfied:
L₁×2<L₂.

9. The test pattern forming method according to claim 1, wherein the medium is rolled paper.

10. A transport adjusting method comprising:
scanning the test patterns formed by the test pattern forming method according to claim 1; and
eliciting a correction value for adjusting the transport of the image forming apparatus based on the scanned test patterns.

11. A transport adjusting method comprising:
scanning the test patterns formed by the test pattern forming method according to claim 2; and
eliciting a correction value for adjusting the transport of the image forming apparatus based on the scanned test patterns.

12. A transport adjusting method comprising:
scanning the test patterns formed by the test pattern forming method according to claim 3; and
eliciting a correction value for adjusting the transport of the image forming apparatus based on the scanned test patterns.

13. A transport adjusting method comprising:
scanning the test patterns formed by the test pattern forming method according to claim 4; and
eliciting a correction value for adjusting the transport of the image forming apparatus based on the scanned test patterns.

14. A transport adjusting method comprising:
scanning the test patterns formed by the test pattern forming method according to claim 5; and
eliciting a correction value for adjusting the transport of the image forming apparatus based on the scanned test patterns.

15. A transport adjusting method comprising:
scanning the test patterns formed by the test pattern forming method according to claim 6; and
eliciting a correction value for adjusting the transport of the image forming apparatus based on the scanned test patterns.

16. A transport adjusting method comprising:
scanning the test patterns formed by the test pattern forming method according to claim 7; and
eliciting a correction value for adjusting the transport of the image forming apparatus based on the scanned test patterns.

17. A transport adjusting method comprising:
scanning the test patterns formed by the test pattern forming method according to claim 8; and
eliciting a correction value for adjusting the transport of the image forming apparatus based on the scanned test patterns.

18. A transport adjusting method comprising:
scanning the test patterns formed by the test pattern forming method according to claim 9; and
eliciting a correction value for adjusting the transport of the image forming apparatus based on the scanned test patterns.

19. An image forming apparatus which forms test patterns used in adjustment transport, comprising:
transport rollers which transport a medium in the sub-scanning direction; and
a plurality of nozzles arranged in the sub-scanning direction,
wherein the transport and main scanning which causes the plurality of nozzles to move in the main scanning direction are repeated to form a plurality of first patterns and a plurality of second patterns,
wherein the plurality of first patterns is formed by repetitive transport of the medium by a first intermittent transport using a first nozzle among the plurality of nozzles,
wherein the plurality of second patterns is formed by repetitive transport of the medium by a second intermittent transport using a second nozzle among the plurality of nozzles, and
wherein the acceleration of the first intermittent transport is more gradual than the acceleration of the second intermittent transport.
